(19) United States
(12) Patent Application Publication
(10) Pub. No.: US 2003/0040339 A1
(43) Pub. Date: Feb. 27, 2003

(54) Method and system for accessing functions of a portable information appliance

(76) Inventor: Allen Chang, San Jose, CA (US)

Correspondence Address: HEWLETT-PACKARD COMPANY, Intellectual Property Administration, P.O. Box 272400, Fort Collins, CO, 80527-2400, US

(21) Appl. No.: 09/934,227

(22) Filed: Aug. 21, 2001

(51) Int. Cl. H04M 1/00

(52) U.S. Cl. 455/563; 455/411; 455/574

(57) ABSTRACT

A method and a system for using a biometric characteristic of an authorized user, such as the user's voice, to grant access to, or activate, functions of the personal information appliance. In one embodiment, a computer implemented method for providing access to functions of a portable information appliance include, while the appliance is operating in a configuration mode, converting input signals from a microphone to a first data set representing a voice of an authorized user and storing the first data set in the portable information appliance. While the portable information appliance is operating in a standby mode, the method further includes converting input signals from the microphone to a second data set representing sound detected at the microphone. Providing access to functions of the portable information appliance then occurs when the first data set matches the second data set.

### FIELD OF THE INVENTION

This invention relates generally to small, portable, hand-held computers, such as Personal Digital Assistants (PDAs), typically carried by individuals to organize daily tasks and routines and to communicate with others. More particularly, the present invention relates to a portable information appliance that includes an enhanced security feature to prevent access of unauthorized users.

### BACKGROUND

Personal Digital Assistants (PDAs) are generally powerful, battery operated computers that fit in the palm of a person's hand. The typical PDA contains a microprocessor and enough memory so that it has the functionality of a general-purpose computer. PDAs are equipped with a few control buttons on the front surface and a pen-like stylus. A user wishing to enter data to the PDA typically uses the stylus to write on the display. With the aid of handwriting recognition software stored in the PDA, the PDA translates the writing into representative codes or characters suitable for more efficient processing and storage by the PDA. The stylus and/or the few control buttons on the front surface can also be used to move a pointer around the display to point at portions of a representation of a traditional keyboard shown on the screen. This also allows for entry of codes or characters.

The power and portability of PDAs have helped the PDA evolve from a data storage device to a telecommunications device. PDAs are now configurable to operate as cellular telephones or to access the Internet. In addition, data in electronic form can be sent or received via the PDA.

With the significant increase in the reliance on PDAs as a data storage and communications tool, the need arises for a security scheme that prevents unauthorized users from gaining access to the authorized user's personal data or cellular telephone account. Similar to the desktop personal computers, PDAs can use password or passcode protection schemes to prevent unauthorized use. However, the password approach can be easily circumvented or the PDA can easily be reprogrammed to accept another password. Therefore, a password protection scheme minimally protects the private information contained in the PDA.

If the PDA is stolen, the original PDA owner can be exposed to unauthorized mobile telephone charges or have his personal privacy compromised because of the confidential information that is stored on the PDA. The confidential information of the authorized user can also be compromised where a non-authorized user uses a PDA that has been properly accessed by the authorized user. This can easily occur when the authorized user is temporarily distracted or leaves the PDA accessible to another for an extended period of time.

Therefore, there is a need for a method and a system that prevents the access by unauthorized users of a PDA that has not been actively used by the authorized user for a predetermined period of time. A method and a system that address the aforementioned problems, as well as other related problems, are therefore desirable.

### SUMMARY OF THE INVENTION

The present invention is directed to addressing the above and other needs in connection with denying access to unauthorized users of a portable information appliance or a PDA. With the present approach, a biometric characteristic of the authorized user, such as the user's voice, grants access to, or activate functions of the portable information appliance. The present invention is exemplified in a number of implementations and applications, some of which are summarized below.

According to one aspect of the invention, a computer implemented method for providing access to functions of a portable information appliance include, while the appliance is operating in a configuration mode, converting input signals from a microphone to a first data set representing a voice of an authorized user and storing the first data set in the portable information appliance. While the portable information appliance is operating in a standby mode, the method further includes converting input signals from the microphone to a second data set representing sound detected at the microphone. Providing access to the functions of the portable information appliance then occurs when the first data set matches the second data set.

According to another aspect of the invention, a computer implemented method for providing access to functions of a portable information appliance includes, while in the configuration mode, using a biometric module coupled to or integral with the appliance to convert input signals to a first data set representing a biometric characteristic of an authorized user and store the data set in memory. While in a standby mode, the biometric characteristic of a potential user, such as a fingerprint, is converted into a second data set and is compared with the stored data set. Access to the functions of the portable information appliance is granted when the first and second data sets match.

The above summary of the present invention is not intended to describe each illustrated embodiment or every implementation of the present invention. The figures in the detailed description that follow more particularly exemplify these embodiments.

### BRIEF DESCRIPTION OF THE DRAWINGS

Various aspects and advantages of the invention will become apparent upon review of the following detailed description and upon reference to the drawings in which:

FIG. 1 is a block diagram of a portable information appliance having an enhanced user security system configured in accordance with an example embodiment of the invention; and

FIG. 2 is a flowchart illustrating an example process of configuring a portable information appliance to respond to an authorized user's voice commands in accordance with an example embodiment of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

Various embodiments of the present invention are described that use a biometric characteristic of the authorized user, such as the user's voice, to grant access to, or activate, functions of the portable information appliance. For purposes of this application, the portable information appliances include, but are not necessarily limited to, portable personal computers, internet appliances, portable digital devices, such as PDAs, one and two-way pagers and mobile communication devices. In addition, biometric characteristics of the authorized user include, but are not necessarily limited to, voice, fingerprints and the retina. Those skilled in the art will appreciate that the invention could be implemented in a variety of programming languages, computer platforms and communications systems.

In an example embodiment, a portable information appliance converts input signals from a microphone to a first data set representing a voice of an authorized user and stores the first data set in the portable information appliance during a configuration mode. The portable information appliance also converts input signals from the microphone to a second data set representing sound detected at the microphone while the appliance is in a standby mode. The portable information appliance enters an operations mode and permits access to functions of the appliance by the authorized user when the first data set matches the second data set. The appliance is also configured, while in the operations mode, to convert additional input signals from the microphone to a third data set representing sounds detected at the microphone and to store the third data set for subsequent playback. The appliance returns to the standby mode after a selected period of inactivity or when the user actuates a hot key instructing the appliance to return to the standby mode.

In related embodiment, the portable information appliance includes a biometric module that converts a biometric characteristic of the authorized user into data sets and stores the data sets for later use in authentication procedure. The biometric module includes, but is not necessarily limited to, a fingerprint scanning device or a retinal scanning device that converts the fingerprint or retinal print of the authorized user into a data set that can be stored for later use. Access to the portable information appliance is granted to a user when the scanned print matches the data set in storage. In another related embodiment, the appliance includes an alarm feature that alerts the authorized user that a third party is attempting authentication to access the functions of the appliance.

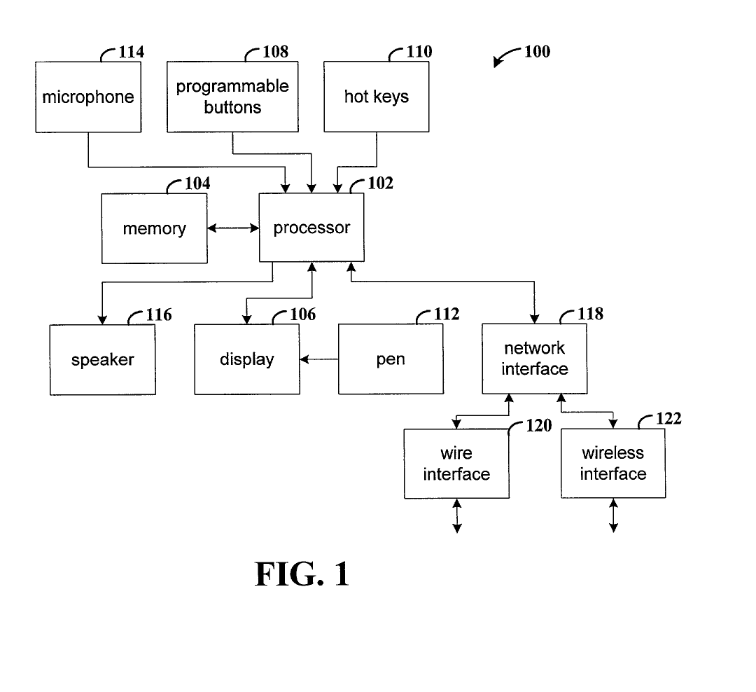

Referring now to the figures, FIG. 1 is a block diagram of a portable information appliance 100 having an enhanced user security system configured in accordance with an example embodiment of the invention. In this example embodiment, portable information appliance 100 is configured to include a microprocessor 102 coupled to a memory arrangement 104 that includes an operating system and a set of application software. Appliance 100 further includes a display screen 106, which can be, but is not necessarily limited to, a liquid crystal display (LCD). Appliance 100 also includes a set of programmable buttons 108, a set of hot keys 110 and a stylus-type pen 112 that are used collectively for programming and entering data into appliance 100. A microphone 114 and a speaker 116 are coupled to microprocessor 102, which is configured to perform digital signal processing functions on signals received from microphone 114.

In a related embodiment, the appliance includes a network interface 118, such as a modem or a LAN card, which facilitates “wire” and “wireless” communications. A communications module 120 engages “wire” communication systems while a wireless communications module 122 engages mobile or WAP-based (Wireless Application Protocol) communication systems. In another related embodiment, appliance 100 is configurable to accept all voice commands for programming or recording purposes, thereby dispensing with the need for the programmable buttons or the stylus pen.

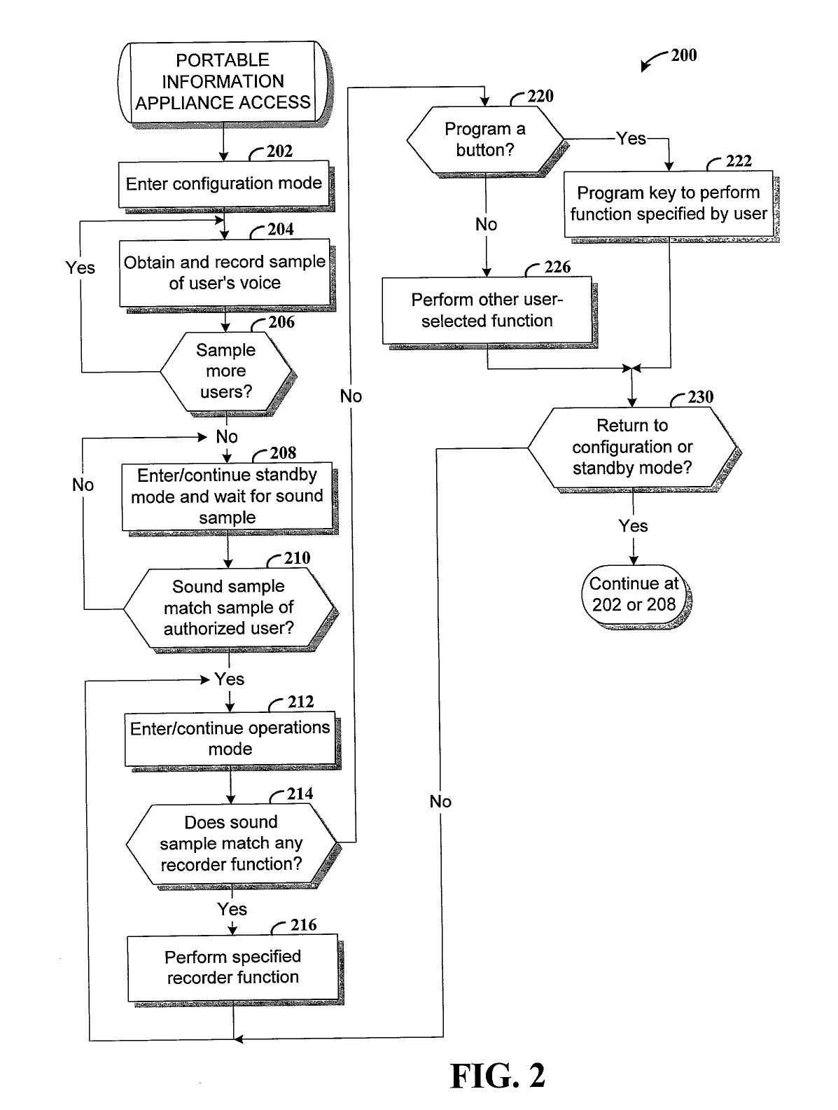

In the present embodiment, security for the authorized user is ensured by granting access to the functions of appliance 100 after the voice of the authorized user is recognized by appliance 100. The ability of programming appliance 100 to utilize the voice recognition security feature is discussed in detail in connection with FIG. 2.

In another embodiment, appliance 100 is configurable to utilize another biometric characteristic of the authorized user, other than the voice of the user, to grant access to the authorized user. In this example embodiment, microphone 114 is substituted with a biometric pad that is configured to recognize a fingerprint of the authorized user. During the configuration mode, the fingerprint of the authorized user is converted to a data set and stored in memory 104. Recognition of the authorized user's fingerprint while in the standby mode, by matching the fingerprint presented with the stored data set, grants the authorized user access to the functions of the appliance.

In a related example embodiment, microphone 114 is substituted with a biometric scanning device that is configured to recognize the retina of the authorized user. During the configuration mode, the authorized user's retina is scanned and a digital representation of the retinal scan is stored in memory 104. Recognition of the authorized user's retinal scan or print while in the standby mode, by matching the retinal scan with the stored data set, grants the authorized user access to the functions of the appliance.

FIG. 2 is a flowchart illustrating an example process 200 of configuring a portable information appliance to respond to an authorized user's voice commands in accordance with an example embodiment of the invention. In this example embodiment, the authorized user of appliance 100 turns on the appliance and enters the configuration mode at step 202. At step 204, the appliance obtains and records a sample of the authorized user's voice and then prompts the user at step 206 to determine whether sampling of more users is necessary. If the appliance is to sample more users, the process returns to step 204 to obtain and record an additional sample or to record additional samples. The additional voice samples are digitized and stored in memory for later voice print matching when access to the appliance is sought.

If additional user voice samples will not be taken, at step 208 the appliance enters into a standby mode and waits for a sound sample. At step 210, the appliance determines whether the sound sample detected at the microphone matches a sample of an authorized user. If no match occurs, the appliance continues in standby mode. If a match occurs, at step 212 the appliance enters an operations mode.

While the appliance is in the configuration mode, the appliance is also configured to function as a sound recorder that is responsive to a plurality of recorder-command data sets. Each recorder-command data set is generated with a voice command and is then digitized and stored in memory. Each recorder-command data set corresponds to a particular sound recorder function. When a voice command is detected which matches a stored recorder-command data set, the appliance commences one of several sound recorder functions. For example, the appliance commences the sound recording function upon detecting the “record” command from the authorized user. The appliance matches the voice sample (or voiceprint) to that of the authorized user as well as to the command stored in memory.

While in the operations mode, the appliance monitors for sound via the microphone. At step 214, upon detecting a sound the appliance attempts to match the sound sample with any record-command data set to determine if a sound recorder function is being requested. At step 216, the selected or specified recorder function is performed when the sound sample matches any one of the stored record-command data sets. When the sound sample does not match any of the stored record-command data sets, the appliance continues in the operations mode.

In a related example, when the sound sample does not match any of the record-command data sets at step 220, the appliance awaits instructions on whether to enter a program-button mode. While in the operations mode, the appliance enters the program-button mode in response to a selected user input signal. In programming the buttons, the appliance associates a user-specified set of functions with a user-selected programmable button 108. In response to a user selection of the programmable button, the appliance at step 222 performs the set of user-specified functions associated with a programmable button. In one example embodiment, the user-specified set of functions is entered via the user's voice commands. If the user is not interested in programming any of the buttons on the appliance, the user at step 226 continues to perform other selected functions on the appliance.

At step 230, the appliance awaits instructions on whether to return to the configuration mode at step 202 or to return to the standby mode at step 208 to await further instructions. If the user at step 230 chooses to return to the operations mode, at step 212 the user prompts the appliance to return to the operations mode to await further instructions. When a selected period of inactivity transpires, the appliance will automatically return to the standby mode. In a related embodiment, the appliance transitions into the standby mode in response to a user input signal, such as a voice command or the actuation of one of the hot keys or programmable buttons. The appliance is also configurable to transition into the standby mode when power to the appliance is initially applied.

The present invention is believed to be available to users of personal computers, mobile telephones, PDAs, pagers and other digital communication and storage devices, such as Internet appliances, which store confidential information for the user. The present invention has been found to be particularly useful in substantially increasing the level of security of confidential information stored in portable information appliances. Other aspects and embodiments of the present invention will be apparent to those skilled in the art from consideration of the specification and practice of the invention disclosed herein. It is intended that the specification and illustrated embodiments be considered as examples only, with a true scope and spirit of the invention being indicated by the following claims.

What is claimed is:

1. A computer-implemented method for providing access to functions of a portable information appliance, comprising:
while the portable information appliance is operating in a configuration mode, converting input signals from a microphone to a first data set representing a voice of an authorized user and storing the first data set in the portable information appliance; and
while the portable information appliance is operating in a standby mode, converting input signals from the microphone to a second data set representing sound detected at the microphone, and if the first data set matches the second data set, providing access to functions of the portable information appliance.

2. The method of claim 1, further comprising:
automatically placing the portable information appliance into an operations mode if the first data set matches the second data set; and
while the portable information appliance is operating in the operations mode, converting input signals from the microphone to a third data set representing sound detected at the microphone and storing the third data set for subsequent playback.

3. The method of claim 2, further comprising:
comparing the third data set to each of a plurality of recorder-command data sets, wherein each of the recorder-command data sets is associated with a sound recorder function performed by the portable information appliance; and
performing the sound recorder function associated with a recorder-command data set that matches the third data set.

4. The method of claim 2, further comprising automatically returning the portable information appliance to the standby mode after a selected period of inactivity.

5. The method of claim 2, further comprising returning the portable information appliance to the standby mode in response to a user input signal.

6. The method of claim 1, further comprising
while the portable information appliance is operating in the configuration mode, converting input signals from a microphone to a plurality of first data sets representing voices of a plurality of authorized users and storing the plurality of first data sets in the portable information appliance; and
if any of the plurality of first data sets matches the second data set, providing access to functions of the portable information appliance.

7. The method of claim 1, further comprising automatically placing the portable information appliance in the standby mode when power is initially applied to the appliance.

8. The method of claim 1, further comprising:
entering a program-button mode in response to a selected user input signal while the portable information appliance is operating in the operations mode;
associating a user-specified set of functions with a user-selected programmable button while the portable information appliance is operating in the program-button mode; and
performing the set of user-specified functions associated with a programmable button in response to a user selection of the programmable button while the portable information appliance is operating in the operations mode.

9. The method of claim 4, further comprising automatically placing the appliance in a power saving mode after a second selected period of inactivity.

10. A system for providing access to functions of a portable information appliance, the system comprising:
means for converting input signals from a microphone to a first data set representing a voice of an authorized user and storing the first data set in the portable information appliance, while the portable information appliance is operating in a configuration mode; and
means for converting input signals from the microphone to a second data set representing sound detected at the microphone and, if the first data set matches the second data set, means for accessing the functions of the portable information appliance, while the portable information appliance is operating in a standby mode.

11. A computer-implemented method for providing access to functions of a portable information appliance, comprising:
while the portable information appliance is operating in a configuration mode, converting input signals from a biometric module to a first data set representing a biometric characteristic of an authorized user and storing the first data set in the portable information appliance; and
while the portable information appliance is operating in a standby mode, converting input signals from the biometric module to a second data set representing the biometric characteristic detected at the biometric module, and if the first data set matches the second data set, providing access to functions of the portable information appliance.

12. The method of claim 11, wherein the biometric module includes a fingerprint sensing pad adapted to convert the input signals into a data set representing the biometric characteristic of the authorized user.

13. The method of claim 11, wherein the biometric module includes a retinal scanning device adapted to convert the input signals into a data set representing the biometric characteristic of the authorized user.

14. The method of claim 11, wherein the biometric module includes a microphone and a digital signal processor that interface with a memory arrangement to recognize a voice of the user.

15. A system for providing access to functions of a portable information appliance, comprising:
means for converting input signals from a biometric module to a first data set representing a biometric characteristic of an authorized user and storing the first data set in the portable information appliance, while the portable information appliance is operating in a configuration mode; and
means for converting input signals from the biometric module to a second data set representing the biometric characteristic detected at the biometric module, and if the first data set matches the second data set, means for accessing the functions of the portable information appliance, while the portable information appliance is operating in a standby mode.
